(19) United States
(12) Patent Application Publication
(10) Pub. No.: US 2008/0157976 A1
(43) Pub. Date: Jul. 3, 2008

(54) Transponder Having A Dipole Antenna

(75) Inventors: Ralf Wolfgang God, Dresden (DE); Hans-Peter Monser, Dresden (DE); Henrik Bufe, Leipzig (DE)

Correspondence Address: BLACK LOWE & GRAHAM, PLLC, 701 FIFTH AVENUE, SUITE 4800, SEATTLE, WA, 98104, US

(73) Assignee: Muhlbauer AG, Roding (DE)

(21) Appl. No.: 11/912,120

(22) PCT Filed: Apr. 21, 2006
(86) PCT No.: PCT/EP06/61723

§ 371 Date: Oct. 19, 2007

(30) Foreign Application Priority Data
Apr. 22, 2005 (DE) 10 2005 018 803.6

(51) Int. Cl. G08B 13/14

(52) U.S. Cl. 340/572.7; 343/878

(57) ABSTRACT

Transponder having a dipole antenna which transmits and receives an electromagnetic wave having a wavelength λ and an RFID chip. The dipole antenna has at least one two-part conductor section with a total length l=λ/2 and the chip is arranged between and connected to the two equal-length parts of the conductor section. Each part is composed of a first region made of a first conductive material which faces towards the RFID chip and has a first length which is proportionately small with regard to the total length, and of a second region made of a second conductive material which faces away from the RFID chip and has a second length.

The invention relates to a transponder comprising a dipole antenna which transmits and receives an electromagnetic wave having a wavelength λ and an RFID chip, wherein the dipole antenna has at least one two-part conductor section with a total length l=λ/2 and the RFID chip is connected to the dipole antenna in a manner matched in terms of current and impedance, according to the preamble of claim 1.

RFID systems (Radio Frequency Identification systems) usually consist of two components, namely a transponder which is fitted to an object to be identified, and a detection device or reader which is designed as a read unit or a read/write unit, depending on the design and the technology used.

The transponder, which represents the actual data carrier of an RFID system, usually consists of a coupling element and of an RFID chip. As the coupling element, use is often made of antennas which have a dipole structure and/or a conductor structure of special geometric shape. Such antennas serve to receive electromagnetic waves arriving from outside and to forward them to the RFID chip, which is correctly coupled in terms of both electrical current and impedance, and also conversely to transmit to the outside or into free space signals which have already been fed into the RFID chip. To this end, the antenna consists of tracks, which are of linear design, and of surfaces made of electrically conductive material which are applied to a non-conductive support material and are matched in terms of their electromagnetic properties to electrical parameters of the RFID chip. In order to couple the chip to the antenna, a coupling region is provided in which the antenna, which is often designed as a rectilinear conductor in this region, is provided with a very short break at the point where the RFID chip is arranged, also referred to as the feeding point. The geometric placement of the coupling region within the conductor structure which forms the antenna depends on the current distribution in the conductor structure and on the specific electrical data of the RFID chip. However, this placement always takes place in the region of resonances within the conductor structure and thus in regions of increased current flow.

UHF RFID systems typically operate in a frequency range of 800-940 MHz or at 2.45 GHz. For a UHF RFID system in accordance with the ETSI standard, which is a standard common to the European Economic Area, a wavelength λ of 34 cm is obtained at a transponder frequency of 869.5 MHz. For antennas based on a λ/2 resonance, a geometric size of approximately 17 cm is thus obtained, which is typical for the half-wave dipole on which this antenna is based. Such antenna conductor structures of different design result on account of different possibilities for electrical matching of the RFID chip to the antenna, in order to optimize the level of efficiency and the read range of the transponder. The mode of action of the antenna depends significantly here on its geometric dimensions, its operating frequency and the specific electrical data of the RFID chip.

One feature common to all antenna structures is the fact that they have a break in their conductor structure in the coupling region of the RFID chip. Feeding of the actual dipole takes place through the RFID chip arranged in this break. This requires particularly conductive and high-quality and cost-intensive materials for forming the dipole antenna, in order to permit correct coupling of the chip to the dipole in terms of the electrical current and the impedance.

Up to now, it has been preferred to use for example etching processes as a cost-effective production technique for dipole antennas in connection with UHF transponders. In such etching processes, a photostructured metal surface made of copper or aluminium for example is etched onto a polymer support and the dipole antenna shape is thereby created.

Alternatively, use is made of so-called additive processes, in which a very thin, structured and conductive layer is joined to a highly conductive, thicker layer by means of electroplating, in order to obtain a reinforcing effect.

Both the etching process and the additive process are characterized by a high number of production steps which have to be carried out using aggressive chemicals on relatively wide support webs. Cost-effective papers which would be a conceivable alternative to the polymer support as the base substrate cannot be used on account of these aggressively reacting chemicals. However, such etching and additive processes exhibit very good resolutions and are able to produce very narrow gaps of approximately 50-100 μm in the region of the feeding point, that is to say in the region of the break in the dipole antenna, said gaps being required for mounting the chip. A chip which is usually used in the transponder sector has an edge length of a few hundred μm, typically of 300 μm to 700 μm.

As an alternative to the etching or additive processes, printing processes are known in which conductive layers which form the dipole antennas are printed on. In this case, base substrates made of plastic or paper can be used as cost-effective support materials. Here, use is made both of silver-filled pastes, which form conductive surfaces upon drying/hardening, and of copper or silver inks which can be printed using the inkjet method and produce conductive layers upon drying/hardening. Such printing processes can be used cost-effectively particularly within the context of manufacture with a high throughput, that is to say with a large number of dipole antennas. However, the achievable conductivity of the pastes and/or inks used lies considerably below that of a closed metal layer, as are obtained for example in the etching or additive process. Moreover, in such printing techniques, the desired resolutions in the fine structure cannot readily be achieved. This in turn leads to more cost-intensive printing processes.

Accordingly, the object of the present invention is to provide a transponder comprising a dipole antenna, which can be produced in a cost-effective, fast and simple manner.

This object is achieved according to the features of claim 1.

One essential aspect of the invention consists in that, in a transponder comprising a dipole antenna which transmits and receives electromagnetic waves having a wavelength λ and an RFID chip, wherein the dipole antenna has at least one two-part conductor section with a total length l=λ/2 and the RFID chip is arranged between and connected to the two equal-length parts of the conductor section, each part is composed of a first region made of a first conductive material which faces towards the chip module and has a first length which is proportionately small with regard to the total length, and of a second region made of a second conductive material which faces away from the chip module and has a second length. The first material may be an electrically conductive metal and/or an electrically conductive metal alloy with a low electrical resistance, wherein the metal may be copper or aluminium. The first region usually comprises a metal structure which is etched onto a support or produced by electroplating. The second region, on the other hand, comprises electrically conductive pastes or inks which are printed onto plastic surfaces or paper, or electrically conductive thin metal films which are applied by vapour deposition.

The two-part conductor section may form the dipole antenna per se as a rectilinear conductor. Such a two-part rectilinear conductor may also be integrated in a loop dipole antenna with or without further antenna sections. Alternatively, the shape of a batwing antenna may be designed in the form of two flat triangles, the triangle tips of which face one another and are spaced apart from one another by the break which receives the chip. It is also conceivable that the two-part conductor section is designed as a triangular surface on one side of the break and as a rectilinear conductor section on the other side of the break.

Even X-shaped antennas, within which the (for example rectilinear) two-part conductor section is arranged, or other antenna structures, such as a large number of linear antenna sections which run together, are conceivable.

Provided that the first and second region can be connected to one another in a cost-effective manner—for example by means of a conductive adhesive—a cost-effective dipole antenna is obtained since large parts of the conductor section are produced from cost-effective materials. Since the costs of the transponder microchip or transponder chip module are predefined, the overall costs of the UHF transponder can be lowered by reducing the production and material costs for the dipole antenna. This is because such a material combination within a dipole antenna makes it possible to make a saving on expensive materials for the second regions, which represent the largest part of the dipole antenna. In the extreme case, a functioning dipole antenna can be formed in its second region from strips of foil which have a thin metallization. Such cost-effective foils are used for example in large quantities in the packaging industry, as known in the case of crisp packets. When using such foils as a conductor structure of the antenna in its second region, a considerable reduction in terms of material costs is achieved.

In the first region, on the other hand, use continues to be made of high-quality materials for providing a good electrically conductive connection to the transponder microchip or chip module, and optionally interposers arranged therebetween which are also necessary for a precisely formed fine structure in the region of the break in the dipole antenna, in which the microchip or chip module is arranged.

As an alternative to a conductive adhesive, it is also possible for a joining, welding or soldering operation or a stitching operation carried out using a conductive wire to be used to connect the first and second region. The length ratio of the first to the second length is preferably 1:9 or below, within a range from 1:8 to 1:12.

The inventive design of the dipole antenna meets the specific physical boundary conditions along the conductor section using the most cost-effective material in each case.

Further advantageous embodiments emerge from the dependent claims.

Advantages and expedient features can be found in the following description in conjunction with the drawing, in which:

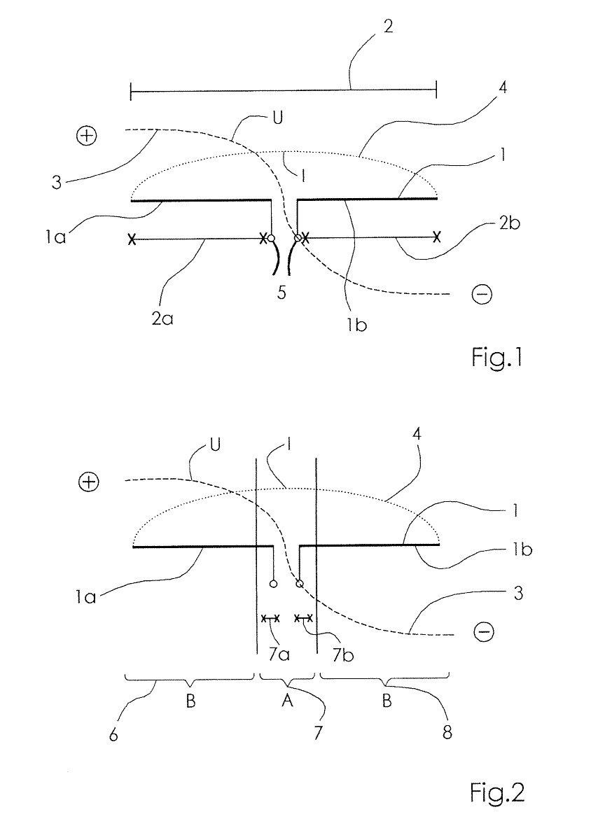

FIG. 1 shows a schematic diagram of a dipole antenna according to the prior art;

FIG. 2 shows a schematic diagram of a dipole antenna according to one embodiment of the invention;

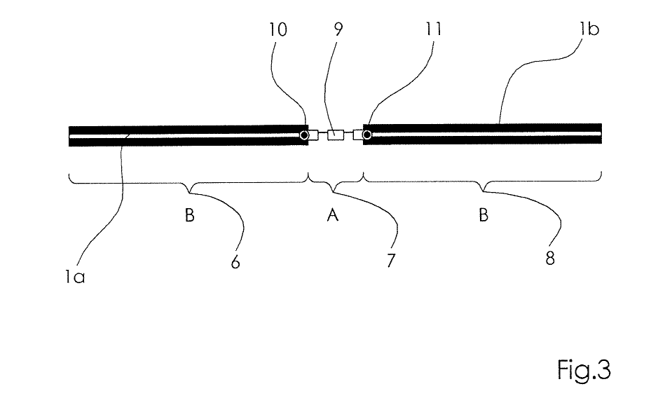

FIG. 3 shows a schematic diagram in plan view of a dipole antenna according to the embodiment of the invention;

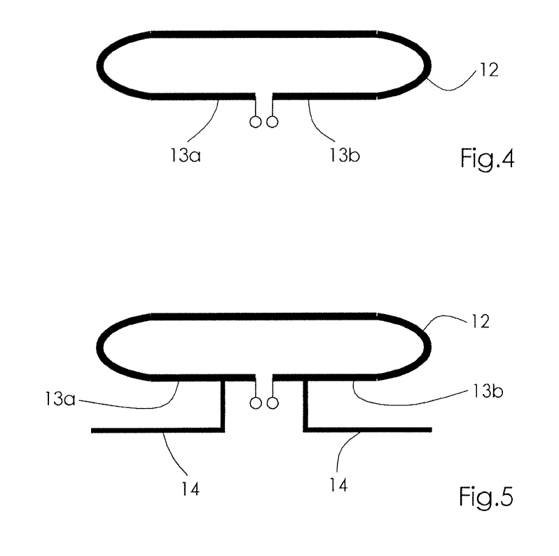

FIG. 4 shows a schematic diagram of a loop dipole antenna according to one embodiment of the invention;

FIG. 5 shows a schematic diagram of a loop dipole antenna according to another embodiment of the invention;

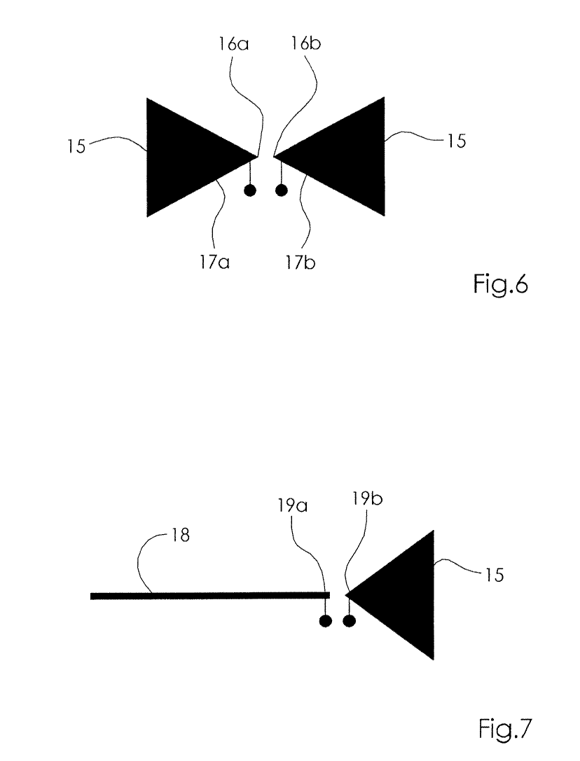

FIG. 6 shows a schematic plan view of a batwing antenna according to another embodiment of the invention;

FIG. 7 shows a schematic plan view of a non-symmetrical antenna according to another embodiment of the invention;

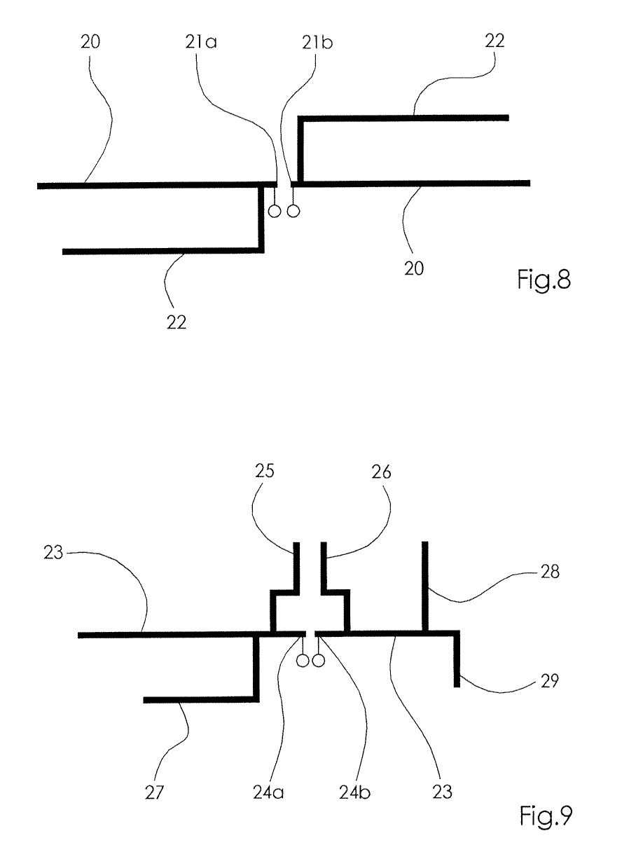

FIG. 8 shows a schematic plan view of an X-shaped antenna according to one embodiment of the invention; and

FIG. 9 shows a schematic plan view of another embodiment of the antenna.

FIG. 1 shows a schematic view of a dipole antenna 1 comprising two equal-length parts 1a and 1b which have the equal lengths 2a and 2b. The dipole antenna 1 as a whole has a total length 2 with l=λ/2, wherein λ is the wavelength of the electromagnetic waves generated by the dipole antenna.

The dipole antenna 1 has a typical voltage gradient 3 and a current distribution 4.

FIG. 2 shows a schematic diagram in side view of a dipole antenna according to one embodiment of the invention. Identical parts and parts which have the same significance are provided with the same references.

On account of the characteristic current distribution 4, which has a maximum in the centre of the conductor section, namely in the region of the feeding point 5, and on account of the voltage gradient 3, which is zero in this region, different specific physical boundary conditions must be met in different parts of the dipole antenna.

Advantageously, the dipole antenna comprising parts 1a and 1b is divided such that a material which is of higher quality and more conductive is used in a first region 7 than in the second regions 6, 8. In this way, the material and production costs for the dipole antenna can be considerably reduced.

The first region 7 is divided into the first regions 7a and 7b, which are assigned to the respective parts 1a and 1b. The first regions 1a and 1b preferably have a first length which is less than 10% of a second length of the second regions 6 and 8.

The regions 6 and 8 are characterized by a large size and a high surface quality, so that charges can be distributed in an optimal manner over the surface. The first region, on the other hand, must have a very precise fine structure in the edge regions on account of the size of the central break in the dipole antenna 1 in the region of the feeding point 5, which lies in the range from 50-100 μm, and this precise fine structure can be achieved by means of high-quality materials using etching or additive processes.

The regions 6, 8 on the one hand and 7 on the other hand are made of different materials, which can be connected to one another by means of a UHF-compatible connecting process. Conductive adhesives are preferably used for this.

Listed in the following tables are characteristic properties of the regions 6, 8 and 7, which are required in order to meet physical boundary conditions for a highly functional dipole antenna for UHF transponders.

| | Region 7 | is met for example by |
|---|---|---|
| electrical | Very high conductivity | Full metallization with |
| | | highly conductive metals (Cu, |
| | | Al) |
| electrical | Transition from fine | Metal structures produced by |
| | connecting structure to | etching or by electroplating |
| | flat contact | |
| optical/ | Fine structure for | Metal structures produced by |
| mechanical | detection marks for chip | etching or by electroplating |
| | placement | |
| mechanical | Very fine connecting | Metal structures produced by |
| | structures for the chip | etching or by electroplating |
| mechanical | Very small gap widths | Metal structures produced by |
| | between chip connections | etching or by electroplating |
| mechanical | Flexible, high-strength | Plastic film |
| | and high-resistance base | |
| | substrate | |
| mechanical | High bending strength of | Plastic film with full |
| | the substrate | metallization |
| mechanical | Material surfaces | Plastic and/or full |
| | suitable for flip-chip | metallization |
| | bonding | |
| mechanical | Heat-resistant | Plastic film with full |
| | materials/surfaces | metallization |
| mechanical | Small, finely structured | Plastic strips with full |
| | region which repeats at | metallization, structured in |
| | high density for | the etching or additive |
| | efficient chip placement | process, for example in the |
| | | standardized 35 mm format |
| mechanical | Fine structures which can | Fine structures from full |
| | be connected to the | metal surface |
| | microchip in a stable and | |
| | durable manner by means | |
| | of conductive adhesives | |

| | Region 6, 8 | is met for example by |
|---|---|---|
| electrical | Closed conductive surface | Printed conductive pastes or |
| | for charge propagation | inks, vapour-deposited thin |
| | | metal films on plastic |
| | | surfaces or paper |
| electrical | Large conductive | Printed conductive pastes or |
| | structures | inks, vapour-deposited thin |
| | | metal films on plastic |
| | | surfaces or paper |
| mechanical | Only a relatively coarse | Printing, metallizing with |
| | resolution of the lateral | shadow masks, structuring by |
| | structures is required | cutting |
| mechanical | Only low mechanical | Printed conductive pastes or |
| | strength is required, | inks, vapour-deposited thin |
| | since reinforcement | metal films on plastic |
| | usually takes place by | surfaces or paper |
| | means of additional top | |
| | layer | |

FIG. 3 shows a schematic plan view of a dipole antenna according to one embodiment of the invention. Identical parts and parts which have the same significance are provided with the same references. It can clearly be seen from the diagram shown in FIG. 3 that a transponder microchip 9 is arranged within the break in the dipole antenna. This transponder microchip 9 is connected by means of connecting faces to the first regions 7a and 7b, which are in turn connected via conductive adhesive points 10, 11 to the second regions 1a and 1b of the conductor section of the dipole antenna.

Here, the first regions are formed from copper layers having a thickness of 17 μm, which are applied to PET by means of an etching process. As a result, finely structured surfaces with fully metallic structures are obtained.

The second regions 6, 8, on the other hand, may in this case consist of foil strips with a thin metallization, as exist in the simplest case in a crisp packet for example.

The conductive adhesive which is used to connect the first and second regions of the dipole antenna is preferably a hot-melt adhesive which is filled with small metal particles. By heating the adhesive and applying pressure, a conductive connection is produced in the region of the points 10, 11.

FIG. 4 shows a schematic diagram of a loop dipole antenna according to another embodiment of the invention. In this loop dipole antenna, a rectilinear two-part conductor section 13a, 13b is integrated within a loop-shaped antenna conductor 12.

FIG. 5 shows the loop dipole antenna already shown in FIG. 4, with further rectilinear conductor sections 14 connected thereto.

FIG. 6 shows a schematic plan view of a so-called batwing antenna as two triangular surfaces, the tips of which point towards one another and are spaced apart from one another by the break, in which the chip is arranged. Each triangular surface 15 is divided into a first region 16a, 16b, which consists of low-resistance, high-quality conductive material, and a second region 17a, 17b which consists of a material which is of lower quality and higher resistance.

FIG. 7 shows a schematic diagram of a non-symmetrical antenna form, in which one half is formed of a triangular surface 15 and the other half is formed of a linear antenna section 18. The sections 19a and 19b once again form first regions of the two-part conductor sections 15, 18.

FIG. 8 shows a schematic diagram of another antenna form. The antenna, which in this case is X-shaped, is composed of two linear antenna sections 20 with first regions 21a and 21b and further linear sections 22.

FIG. 9 shows another embodiment of a possible antenna. Once again, two linear parts 23 comprise first regions 24a and 24b and further linear sections 25, 26, 27, 28 and 29.

All the features disclosed in the application documents are claimed as essential to the invention in so far as they are novel individually or in combination with respect to the prior art.

### LIST OF REFERENCES

1 dipole antenna
1a, 1b; 13a, 13b parts of the dipole antenna
2 total length of the dipole antenna
2a, 2b lengths of the parts of the dipole antenna
3 voltage gradient
4 current intensity gradient
5 feeding point
6, 8, 17a, 17b second regions
7, 7a, 7b; 16a, 16b; 19a, 19b; 21a, 21b; 24a, 24b first region
9 microchip/chip module
10, 11 conductive adhesive points
12 loop dipole antennas
14 rectilinear antenna sections
15 triangular antenna surfaces
18, 20, 22, 23, 25, 26, 27, 28, 29 linear antenna section

1. A transponder comprising:
a dipole antenna configured to transmit and receive an electromagnetic wave having a wavelength λ; and
an RFID chip,
wherein the dipole antenna has at least one two-part conductor section with a total length l=λ/2 and the RFID chip is arranged between and connected to the two equal-length parts of the conductor section, each part is composed of a first region made of a first conductive material which faces towards the RFID chip and has a first length which is proportionately small with regard to the total length, and of a second region made of a second conductive material which faces away from the RFID chip and has a second length.

2. The transponder according to claim 1, wherein the first material is an electrically conductive, low-resistance metal and/or an electrically conductive, low-resistance metal alloy.

3. The transponder according to claim 2, wherein the metal comprises copper or aluminium.

4. The transponder according to claim 1, wherein the first region comprises a metal structure which is etched onto a support or produced by electroplating.

5. The transponder according to claim 1, wherein the second material comprises one or more electrically conductive pastes or inks which are printed onto plastic surfaces or paper, or electrically conductive thin metal films which are applied by vapour deposition, said second material being of higher resistance than the first material.

6. The transponder according to claim 1, wherein the first and second regions are connected to one another by means of a conductive adhesive in a boundary region.

7. The transponder according to claim 1, wherein the first and second regions are connected to one another by at least one means of one or more of a joining, welding or soldering operation or means of a stitching operation carried out using a conductive wire.

8. The transponder according to claim 1, wherein the length ratio of the first to the second length lies in a range from 1:8 to 1:12, preferably below 1:9.

9. The transponder according to claim 1, wherein the two-part conductor section is rectilinear.

10. The transponder according to claim 1, wherein the two-part conductor section is integrated in a loop dipole antenna.

11. The transponder according to claim 1, wherein the two-part conductor section comprises two triangular surfaces, wherein the chip is arranged between two mutually facing triangle tips thereof.

12. The transponder according to claim 1, wherein the two-part conductor section comprises a rectilinear part and a triangular part, one triangular tip of which points towards one end of the rectilinear part.

13. The transponder according to claim 1, wherein the two-part conductor section is arranged in an X-shaped antenna.
